(19) United States
(12) Patent Application Publication
(10) Pub. No.: US 2019/0263330 A1
(43) Pub. Date: Aug. 29, 2019

(54) DRIVER ASSIST SYSTEM

(71) Applicant: TRW AUTOMOTIVE U.S. LLC, Livonia, MI (US)

(72) Inventor: DARRYL EDWARDS, Novi, MI (US)

(21) Appl. No.: 16/284,008

(22) Filed: Feb. 25, 2019

Related U.S. Application Data
(60) Provisional application No. 62/635,071, filed on Feb. 26, 2018.
(60) Provisional application No. 62/635,571, filed on Feb. 27, 2018.

(51) Int. Cl. B60R 11/04; C09J 11/00

(52) U.S. Cl. CPC B60R 11/04; B60R 2011/0026; C09J 11/00

(57) ABSTRACT

The present invention is directed to a driver assist system for a vehicle including a housing which supports a device for sensing the surroundings of the vehicle. An adhesive connects the driver assist system to the vehicle. At least one of the housing and the adhesive connecting the driver assist system to the vehicle having radiant energy reflecting elements.

### RELATED APPLICATIONS

This application claims priority from U.S. Provisional Application No. 62/635,071, filed Feb. 26, 2018 and U.S. Provisional Application No. 62/635,571, filed Feb. 27, 2018, the entirety of which are incorporated herein by reference.

### FIELD OF THE INVENTION

The present invention relates to a driver assist system, and, more specifically, to a driver assist system having radiant energy reduction elements.

### BACKGROUND

Driver assist systems are incorporated in a vehicle to acquire information and provide the acquired information to a vehicle safety system designed to assist the driver. A driver assist system may be mounted on or near the vehicle windshield to ensure a desired field of view. The driver assist system may include multiple electronic components to process the information acquired by the driver assist system and communicate the processed information via electronic signals to one or more other systems within the vehicle. The driver assist system may absorb radiant energy through the windshield or from other heat sources that may cause damage to the driver assist system.

### SUMMARY OF THE INVENTION

The present invention is directed to a driver assist system for a vehicle including a housing which supports a device for sensing the surroundings of the vehicle. An adhesive connecting the driver assist system to the vehicle. At least one of the housing and the adhesive connecting the driver assist system to the vehicle having radiant energy reflecting elements.

In another aspect of the present invention, the driver assist system includes a bracket configured and dimensioned to receive and retain the housing. The adhesive connects the bracket to a window of the vehicle. The adhesive includes the radiant energy reflecting elements. The radiant energy reflecting elements are at least one of pigments, colorants, dyes and metals.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic pictorial view of a driver assist system constructed in accordance with the present invention; and

FIG. 2 is a schematic side view of a bracket of the driver assist system of FIG. 1 shown connected to a vehicle window.

### DETAILED DESCRIPTION

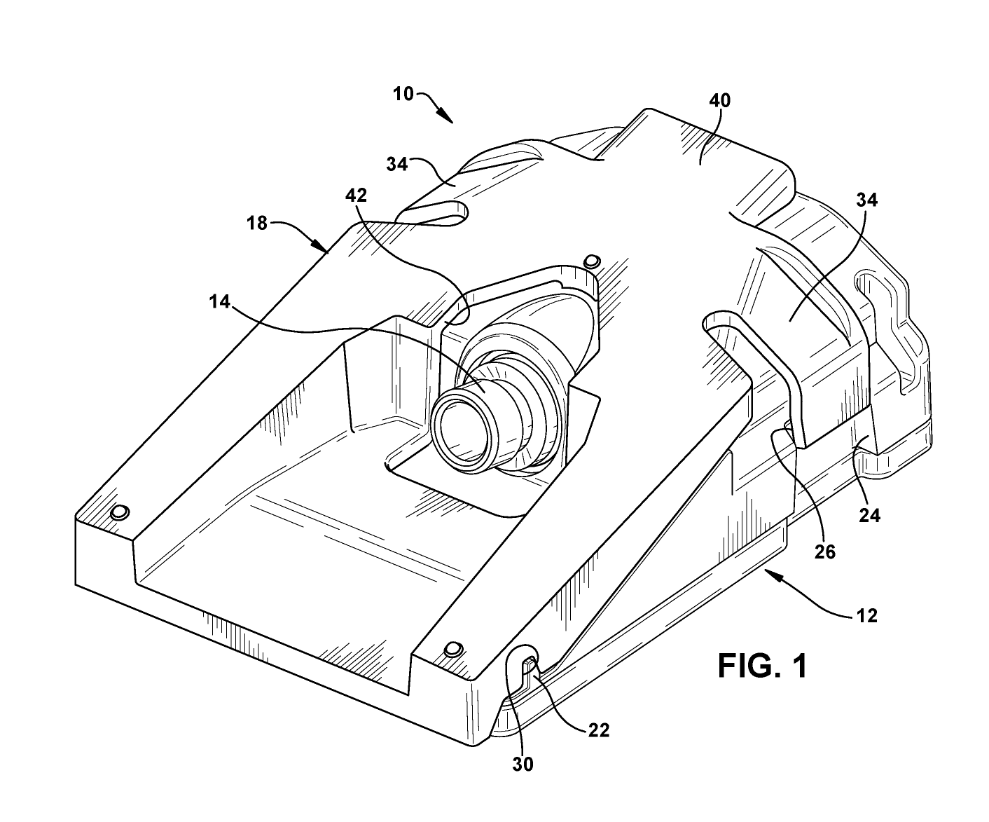

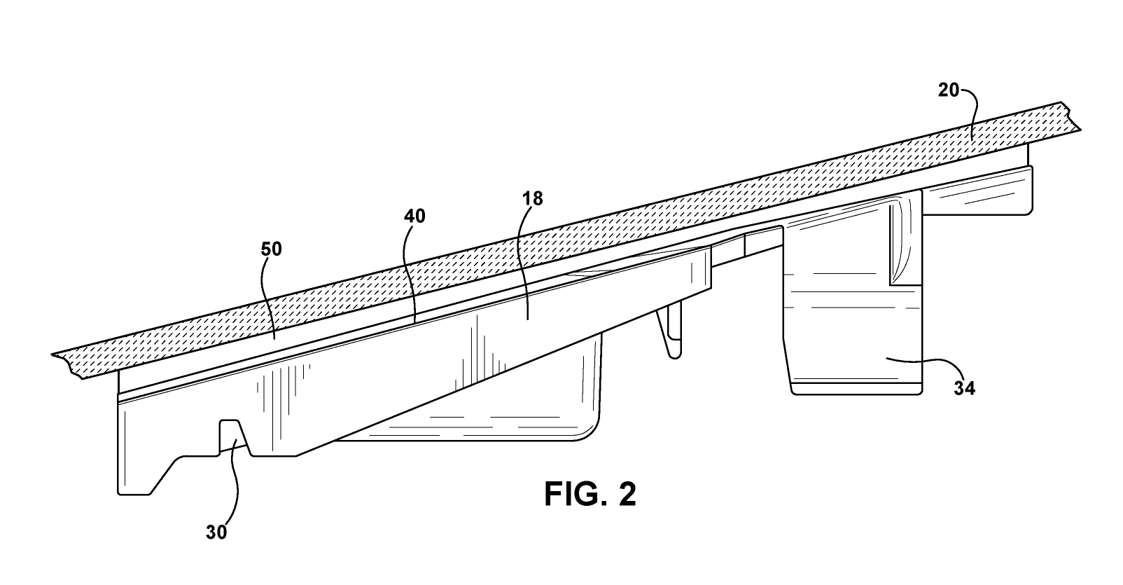

A driver assist system or apparatus 10 constructed in accordance with the present invention is illustrated in FIGS. 1 and 2. The driver assist system 10 includes a housing 12 that contains or supports a sensing device 14 for sensing the surroundings of a vehicle, such as a camera 14. It is contemplated that the device 14 for sensing the surroundings of the vehicle may include a camera, a lidar detector, a radar detector and/or IPM. The driver assist system 10 also includes a mounting bracket 18 that connects the driver assist system 10 to a vehicle window 20. The bracket 18 is configured and dimensioned to receive and retain the housing 12.

The camera 14 is operatively connected to data processing circuitry within the housing 12 for processing any image within the field of view of the camera. The circuitry within the housing 12 is connectable with other vehicle systems. For the purposes of explanation, the driver assist system 10 is a forward looking system and is mounted to the front windshield 20 of a vehicle.

The driver assist system 10 views the environment forward of the vehicle and analyzes monitored information such as lane keeping, roadway departures, pedestrian information, road sign information, etc. The analyzed information is then further processed and used by vehicle control systems and/or warning systems. Those skilled in the art will appreciate that the present invention is applicable to other driver assist systems such as a rearward facing system for monitoring the environment rearward of the vehicle.

The housing 12 may have any construction or configuration suitable to contain or support the sensing device 14 and suitable to be received and retained in the bracket 18. The housing 12 has alignment tabs 22 that project upwardly along sides of the housing adjacent a first or front end of the housing, only one tab 22 is shown in FIG. 1. The housing 12 has notches 24 with locking projections 26 in the sides of the housing adjacent a second or rear end of the housing, only one notch and projection is shown in FIG. 1.

The mounting bracket 18 includes forward alignment slots 30 and rearward locking arms 34 that aid in securing the housing 12 into the mounting bracket 18, only one alignment slot is shown in FIGS. 1 and 2. The mounting bracket 18 has an outer mounting face 40 that, when mounted to the vehicle, faces the windshield 20. A camera viewing window 42 is provided in the mounting bracket 18 so as to permit an unobstructed forward field of view for the camera 14 in front of the vehicle.

After the mounting bracket 18 is secured to the windshield 20, the housing 12 is snapped into the bracket. The alignment tabs 22 on the housing 12 are inserted into the front alignment slots 30 on the bracket 18. After the tabs 22 are inserted into the slots 30, the rear end of the housing 12 is pivoted into the locking arms 34. The locking arms 34 are flexible to permit the housing 12 to be inserted between the arms. The locking arms 34 engage the locking projections 26 to lock the housing 12 to the bracket 18.

The bracket 18 may be attached to the windshield 20 or any other part of the vehicle, such as a dash board, grill or bumper. The bracket 18 may be attached or secured to the vehicle via a layer of adhesive 50. The adhesive 50 may include radiant energy reflecting elements, such as pigments, colorants, dyes and/or metals. The radiant reflecting elements reflect radiant energy, such as solar and/or thermal energy including near infrared, visible and ultraviolet energy, away from the bracket 18 and housing 12 that impinges on and/or is reflected onto the adhesive 50 to prevent the radiant energy from being absorbed by the adhesive, bracket and/or housing. The radiant energy reflecting elements may reflect energy from sunlight or a high temperature thermal radiating heat source, such as an engine compartment, under dash hot duct, hose or pipe. The radiant energy reflecting elements help prevent damage to the adhesive 50, bracket 18 and housing 12 due to radiant energy. The radiant energy reflecting elements help prevent damage to the camera and electronic components within the housing.

It is contemplated that any of the adhesive 50, bracket 18, housing 12, windshield 20, including the internal plastic safety laminate and/or windshield silkscreen sunshade may be impregnated, coated and/or painted with radiant energy reflecting elements. Although the driver assist system 10 is described as being adhered to the vehicle, the driver assist system may be connected to the vehicle with the adhesive 50 with the radiant reflecting elements along with any other desired connection.

Although the bracket 18 is described as being attached to the vehicle and the housing 12 retained by the bracket, it is contemplated that the housing may be attached directly to the vehicle without the use of the bracket. The housing may be adhered to the window with the adhesive 50 having the radiant reflecting elements.

From the above description of the invention, those skilled in the art will perceive improvements, changes and modifications. Such improvements, changes and modifications within the skill of the art are intended to be covered by the appended claims.

Having described the invention, the following is claimed:

1. A driver assist system for a vehicle comprising:
a housing which supports a device for sensing the surroundings of the vehicle; and
an adhesive connecting the driver assist system to the vehicle;
at least one of the housing and the adhesive connecting the driver assist system to the vehicle having radiant energy reflecting elements.

2. The driver assist system of claim 1 further including a bracket configured and dimensioned to receive and retain the housing, the adhesive connecting the bracket to the vehicle.

3. The driver assist system of claim 2 wherein at least one of the housing, the adhesive and the bracket has the radiant energy reflecting elements.

4. The driver assist system of claim 1 wherein the adhesive includes the radiant energy reflecting elements.

5. The driver assist system of claim 1 wherein the adhesive connects the driver assist system to a window of the vehicle.

6. The driver assist system of claim 1 wherein the radiant energy reflecting elements are at least one of pigments, colorants, dyes and metals.

7. The driver assist system of claim 1 further including a bracket configured and dimensioned to receive and retain the housing, the adhesive connecting the bracket to a window of the vehicle, the adhesive including the radiant energy reflecting elements, the radiant energy reflecting elements being at least one of pigments, colorants, dyes and metals.
